(19) United States
(12) Patent Application Publication
(10) Pub. No.: US 2023/0238002 A1
(43) Pub. Date: Jul. 27, 2023

(54) SIGNAL PROCESSING DEVICE, SIGNAL PROCESSING METHOD AND PROGRAM

(71) Applicant: SONY GROUP CORPORATION, TOKYO (JP)

(72) Inventor: MASATO HIRANO, TOKYO (JP)

(21) Appl. No.: 17/999,403

(22) PCT Filed: May 28, 2021
(86) PCT No.: PCT/JP2021/020361

§ 371 Date: Nov. 21, 2022

(30) Foreign Application Priority Data
Jun. 1, 2020 (JP) 2020-095351

(51) Int. Cl. G10L 17/02; G10L 17/18; G10L 21/0208; G10L 17/20; G10L 17/06

(52) U.S. Cl. CPC G10L 17/02; G10L 17/18; G10L 21/0208; G10L 17/20; G10L 17/06

(57) ABSTRACT

For example, the accuracy of voice recognition is improved.

A signal processing device includes: a single speech detection unit that detects whether one channel of an input voice signal is a speech of a single speaker; a cluster information updating unit that updates cluster information based on a voice feature quantity when the input voice signal is a speech of a single speaker; a voice segment detection unit that detects a speech segment of a target speaker based on the cluster information; and a voice extraction unit that extracts only the voice signal of the target speaker from a mixed voice signal containing the voice of the target speaker.

### TECHNICAL FIELD

The present disclosure relates to signal processing devices, signal processing methods, and programs.

### BACKGROUND ART

PTL 1 below discloses a technique (voice recognition device) that learns the features of a specific speaker and uses the model obtained by learning to detect the speech segment of the specific speaker.

### CITATION LIST

### Patent Literature

[PTL 1]
JP 6487650B

### SUMMARY

### Technical Problem

In such a field, it is desired to obtain more speaker features and improve voice recognition accuracy.

One object of the present disclosure is to provide a signal processing device, a signal processing method, and a program capable of obtaining more speaker features and improving voice recognition accuracy.

### Solution to Problem

The present disclosure provides, for example,

a signal processing device comprising: a single speech detection unit that detects whether one channel of an input voice signal is a speech of a single speaker;
a cluster information updating unit that updates cluster information based on a voice feature quantity when the input voice signal is a speech of a single speaker;
a voice segment detection unit that detects a speech segment of a target speaker based on the cluster information; and
a voice extraction unit that extracts only the voice signal of the target speaker from a mixed voice signal containing the voice of the target speaker.

In addition, the present disclosure provides, for example,

a signal processing device comprising: a single speech detection unit that detects whether a speech of a single speaker is included in any of a plurality of channels of input voice signals;
a cluster information updating unit that updates cluster information based on a voice feature quantity when any of the plurality of channels of the input voice signals is a speech of a single speaker;
a voice segment detection unit that detects a speech segment of a target speaker based on the cluster information; and
a voice extraction unit that extracts only the voice signal of the target speaker from a plurality of channels of mixed voice signals containing the voice of the target speaker.

In addition, the present disclosure provides, for example,

a signal processing method comprising: allowing a single speech detection unit to detect whether one channel of an input voice signal is a speech of a single speaker;
allowing a cluster information updating unit to update cluster information based on a voice feature quantity when the input voice signal is a speech of a single speaker;
allowing a voice segment detection unit to detect a speech segment of a target speaker based on the cluster information; and
allowing a voice extraction unit to extract only the voice signal of the target speaker from a mixed voice signal containing the voice of the target speaker.

In addition, the present disclosure provides, for example,

a program for causing a computer to execute a signal processing method comprising:
allowing a single speech detection unit to detect whether one channel of an input voice signal is a speech of a single speaker;
allowing a cluster information updating unit to update cluster information based on a voice feature quantity when the input voice signal is a speech of a single speaker;
allowing a voice segment detection unit to detect a speech segment of a target speaker based on the cluster information; and
allowing a voice extraction unit to extract only the voice signal of the target speaker from a mixed voice signal containing the voice of the target speaker.

### BRIEF DESCRIPTION OF DRAWINGS

FIG. 1 is a block diagram showing an example of the overall configuration of a signal processing device according to an embodiment.

FIG. 2 is a flowchart showing the operation flow of the signal processing device according to the embodiment.

FIG. 3 is a flowchart to be referred to when describing an example of processing performed by a clustering unit according to an embodiment.

FIG. 4 is a flowchart to be referred to when describing another example of processing performed by a clustering unit according to an embodiment.

FIG. 5 is a flowchart to be referred to when explaining an example of processing performed by a target speaker voice segment detection unit according to an embodiment.

FIG. 6 is a flowchart to be referred to when explaining another example of processing performed by the target speaker voice segment detection unit according to the embodiment.

FIG. 7 is a flowchart to be referred to when explaining another example of processing performed by the target speaker voice segment detection unit according to the embodiment.

FIG. 8 is a diagram showing a pattern of how each process is performed by the signal processing device according to the embodiment.

FIG. 9 is a block diagram showing an example of the overall configuration of a signal processing device according to a modification.

FIG. 10 is a flow chart showing the operation flow of the signal processing device according to the modification.

FIG. 11 is a diagram for explaining an example of processing performed by a target speaker voice extraction unit according to a modification.

FIG. 12 is a flow chart showing the flow of processing performed by a target speaker voice extraction unit according to a modification.

FIG. 13 is a diagram for explaining an outline of a similarity determination process according to a modification.

FIG. 14 is a flow chart showing the flow of the similarity determination process according to the modification.

FIG. 15 is a flow chart showing a flow of processing performed by a signal processing device according to a modification.

FIG. 16 is a flow chart showing the flow of processing performed by the signal processing device according to the modification.

FIGS. 17A to 17C are diagrams showing examples of GUIs (Graphical User Interfaces) applicable to the present disclosure.

### DESCRIPTION OF EMBODIMENTS

Hereinafter, embodiments and the like of the present disclosure will be described with reference to the drawings. The description will be given in the following order.

### <Issues to be Considered in Present Disclosure>

### One Embodiment

### <Modification>

The embodiments to be described below are preferred specific examples of the present disclosure and content of the present disclosure is not limited to the embodiments.

### <Issues to be Considered in Present Disclosure>

First, in order to facilitate understanding of the present disclosure, issues to be considered in the present disclosure will be described.

In recent years, there has been a demand for a speech transcription system with the tag “who spoke” even when multiple people's speeches overlap. For example, for the purpose of visualizing discussions in an educational field, there are a demand for transcribing the speeches of participants with the information “who spoke”, a demand for automating tasks of adding tags indicating when and who spoke in order to create an archive of TV programs, and a demand for using speech transcriptions with tags in order to create minutes of workplace meetings.

In order to meet such demands, a number of voice extraction techniques have been proposed for extracting the voice of a target speaker (speaker who is the target of voice recognition). However, with the conventional technology, since only pre-recorded voice is used, it is difficult to extract the voice of a new speaker, and there is a problem that the application is limited. In addition, since voice extraction is performed on all mixed voice signals in which the voices of multiple speakers are mixed, there is a high possibility of false detection, and there is a problem that the calculation cost increases. The embodiments of the present disclosure will be described in detail with reference to the above viewpoints.

### One Embodiment

### [Configuration Example of Signal Processing Device]

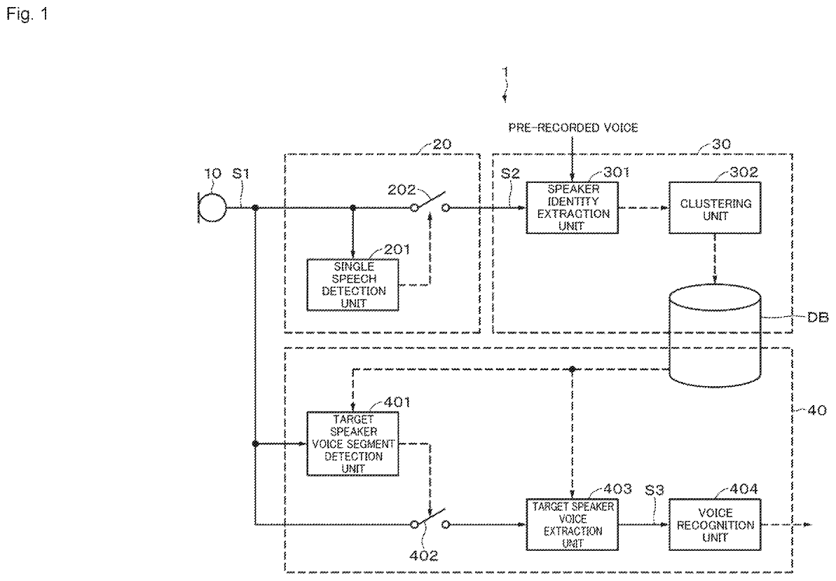

FIG. 1 is a block diagram showing a configuration example of a signal processing device (signal processing device 1) according to the present embodiment. The signal processing device 1 generally includes a microphone 10, a single speech detection system 20, a speaker feature quantity extraction system 30 for extracting a voice feature quantity that is the feature of a speaker's voice, and a target speaker voice recognition system 40 for recognizing the voice of a target speaker, and a database DB. The database DB is connected to each of the speaker feature quantity extraction system 30 and the target speaker voice recognition system 40. In FIG. 1, solid-line arrows mainly indicate the flow of voice signals, and dotted-line arrows indicate the flow of voice feature quantities, commands, and the like.

A voice signal is input to a microphone 10. The input voice signal is converted into a digital signal by an AD (Analog to Digital) converter (not shown). One channel of an input voice signal S1 converted into a digital signal is output from the microphone 10. The input voice signal S1 is a mixed voice signal in which voice signals of a single speaker (single speaker) and voice signals of a plurality of speakers are mixed. The input voice signal S1 is input to the single speech detection system 20 and the target speaker voice recognition system 40, respectively.

The single speech detection system 20 has, for example, a single speech detection unit 201 and a switch 202. The single speech detection unit 201 detects whether the input voice signal S1 is the speech of a single speaker using a known method. Specifically, the single speech detection unit 201 detects whether the voice signal of a predetermined unit (for example, in frame units) of the input voice signal S1 is the speech of a single speaker. When the input voice signal S1 is the speech of a single speaker, a flag indicating this is output from the single speech detection unit 201 to the switch 202, and the switch 202 is turned on. If the input voice signal S1 is not the speech of a single speaker, a flag indicating this is output from the single speech detection unit 201 to the switch 202, and the switch 202 is turned off. Note that the switch 202 may be a physical switch or a digital signal processing switch. In the latter case, turning off the switch 202 is a process of setting the volume to zero. A single speaker voice signal S2 is output from the single speech detection system 20, and the single speaker voice signal S2 is input to the speaker feature quantity extraction system 30.

The speaker feature quantity extraction system 30 has a speaker identity extraction unit 301 and a clustering unit 302, which is an example of a cluster information updating unit. The speaker identity extraction unit 301 extracts a voice feature quantity from the single speaker voice signal S2 corresponding to the speech of the single speaker detected by the single speech detection unit 201. In addition, the speaker identity extraction unit 301 extracts voice feature quantities from pre-recorded voice that has been input in advance (recorded in advance). The pre-recorded voice is the voice signal for each speaker. The voice feature quantity is output as, for example, a vector (hereinafter referred to as a speaker identity vector as appropriate). The speaker identity extraction unit 301 extracts the speaker identity vector using, for example, a neural network.

The clustering unit 302 updates the cluster information based on the speaker identity vector when the input voice signal S1 is the speech of a single speaker. Specifically, the clustering unit 302 adds cluster information based on the voice feature quantity of a new speaker extracted by the speaker identity extraction unit 301 when the single speaker is a new speaker, and updates the cluster information based on the voice feature quantity of an existing speaker extracted by the speaker identity extraction unit 301 when the single speaker is an existing speaker.

A new speaker means a speaker whose cluster information is not stored in the database DB. The existing speaker means a speaker whose cluster information is stored in the database DB. The clustering unit 302 determines whether the speaker is a new speaker or an existing speaker depending on whether cluster information is stored in the database DB.

In the present embodiment, a representative vector corresponding to a predetermined speaker stored in the database DB corresponds to cluster information. In the present embodiment, the database DB stores cluster information corresponding to a predetermined speaker and a speaker identity vector used to calculate the cluster information.

The target speaker voice recognition system 40 has a target speaker voice segment detection unit 401, a switch 402, a target speaker voice extraction unit 403 and a voice recognition unit 404.

The target speaker voice segment detection unit 401 reads the cluster information of the target speaker from the database DB, and detects a speech segment of the target speaker based on the read cluster information. When the speech segment of the target speaker is detected, the target speaker voice segment detection unit 401 outputs a target speaker voice segment flag. The switch 402 is turned on while the target speaker voice segment flag is being output.

The target speaker voice extraction unit 403 extracts only the voice signal of the target speaker from the mixed voice signal containing the voice of the target speaker. The target speaker voice extraction unit 403, for example, reads the cluster information of the target speaker from the database DB, and extracts the voice signal of the target speaker based on the read cluster information. The extracted voice signal (hereinafter referred to as an estimated target voice signal S3 as appropriate) is supplied to the voice recognition unit 404.

The voice recognition unit 404 performs a voice recognition process on the estimated target voice signal S3 using a known voice recognition method. Then, the voice recognition result is output from the voice recognition unit 404. For example, text information, which is the voice recognition result, is output. The voice recognition result is used for the application corresponding to an application device to which the signal processing device 1 is applied. Note that the voice recognition result may be used by a device different from the signal processing device 1.

### [Operation Example of Signal Processing Device]

### (Overall Processing Flow)

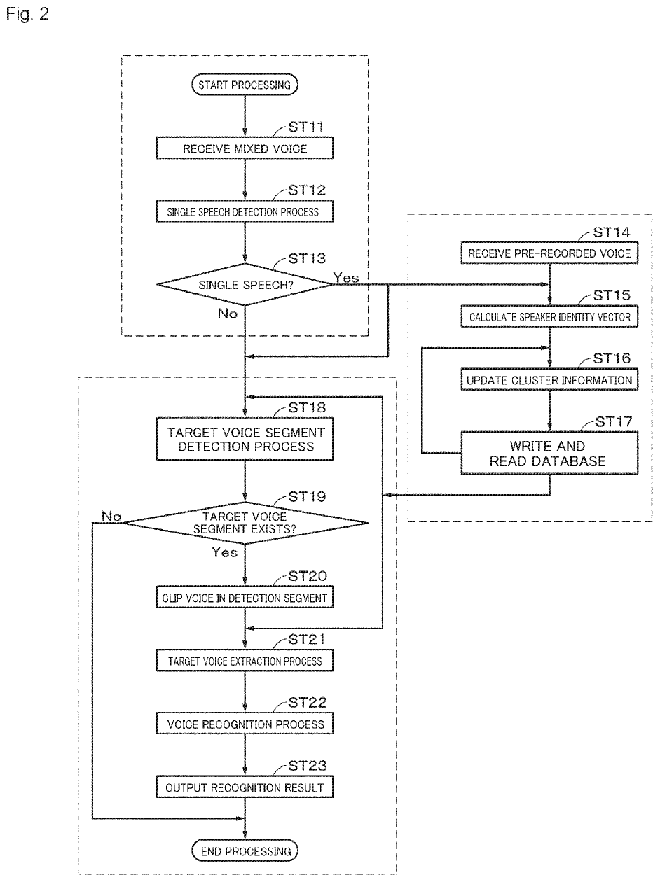

Next, an operation example of the signal processing device 1 will be described. FIG. 2 is a flowchart showing the overall processing flow of the signal processing device 1. In the flowchart shown in FIG. 2, the processing related to steps ST11 to ST13 is performed by the single speech detection system 20, the processing related to steps ST14 to ST17 is performed by the speaker feature quantity extraction system 30, and the processing related to steps ST18 to ST23 is performed by the target speaker voice recognition system 40.

In step ST11, mixed voice is input to the microphone 10. Then, the input voice signal S1 output from the microphone 10 is supplied to the single speech detection unit 201. Then, the processing proceeds to step ST12.

In step ST12, the single speech detection unit 201 performs a single speech detection process. Then, the processing proceeds to step ST13.

In step ST13, the single speech detection unit 201 determines whether a single speech has been detected. If a single speech is detected, the switch 202 is turned on, and processing proceeds to step ST15.

In step ST14, which is the preceding stage of step ST15, pre-recorded voice is input to the speaker identity extraction unit 301. Then, in step ST15, the speaker identity extraction unit 301 calculates speaker identity vectors for the single speaker voice signal S2 and the pre-recorded voice (if there are multiple pre-recorded voices, all of them). Then, the processing proceeds to step ST16.

In step ST16, the clustering unit 302 updates cluster information. Specifically, when the single speaker is a new speaker, the clustering unit 302 adds cluster information based on the voice feature quantity of the new speaker extracted by the speaker identity extraction unit 301, and when the speaker is an existing speaker, updates the cluster information based on the voice feature quantity of the existing speaker extracted by the speaker identity extraction unit 301. Then, the processing proceeds to step ST17.

In step ST17, the clustering unit 302 writes the cluster information updated in the process of step ST16 into the database DB.

Following the determination process related to step ST13 described above, the processing related to step ST18 is performed. That is, the input voice signal S1 is supplied to the target speaker voice recognition system 40. In step ST18, the target speaker voice segment detection unit 401 performs a target voice segment detection process for detecting a target voice segment, which is a voice segment of the target speaker, from the input voice signal S1. The target speaker voice segment detection unit 401 reads the cluster information of the target speaker from the database DB, and uses the cluster information to detect the target voice segment. Then, the processing proceeds to step ST19.

In step ST19, the target speaker voice segment detection unit 401 determines whether a target voice segment exists as a result of the target voice segment detection process. If the target voice segment does not exist, the processing ends. If the target voice segment exists, the switch 402 is turned on, and processing proceeds to step ST20.

In step ST20, a process of clipping the input voice signal S1 in the target voice segment is performed. The clipped voice signal is supplied to the target speaker voice extraction unit 403. Then, the processing proceeds to step ST21.

In step ST21, the target speaker voice extraction unit 403 extracts the target speaker voice from the voice signal supplied to itself. The estimated target voice signal S3, which is the result of the extraction process, is supplied to the voice recognition unit 404. Then, the processing proceeds to step ST22.

In step ST22, the voice recognition unit 404 performs a voice recognition process. Then, the processing proceeds to step ST23.

In step ST23, the voice recognition result (for example, text information or the like) of the voice recognition unit 404 is output. Then, the processing ends.

### (Specific Example of Processing Performed by Speaker Identity Extraction Unit)

Next, a specific example of processing performed by the speaker identity extraction unit 301 will be described. As an example, the speaker identity extraction unit 301 extracts voice feature quantities using a neural network. More specifically, the speaker identity extraction unit 301 receives voice as an input and outputs a vector representing the voice features. In the learning stage, the voices of M speeches of each speaker (that is, N*M in total) are input, and N*M embedding vectors are obtained. This is divided into two batches of N*(M/2) so that the number of speeches of each speaker is exactly half, and respective batches are called enrollment and verification. The average of the embedding vectors corresponding to M/2 speeches of each speaker of the enrollment is calculated to obtain the average embedding vector for a total of N speeches. The cosine similarity between this average embedding vector and each embedding vector of the verification is measured. Unsupervised learning is performed so that this cosine similarity is large for embedding vectors of the same speaker and small for different speakers. The speaker identity extraction unit 301 uses a learning model obtained by such learning to output a speaker identity vector, which is an example of a voice feature quantity.

### (Specific Example of Processing Performed by Cluster Information)

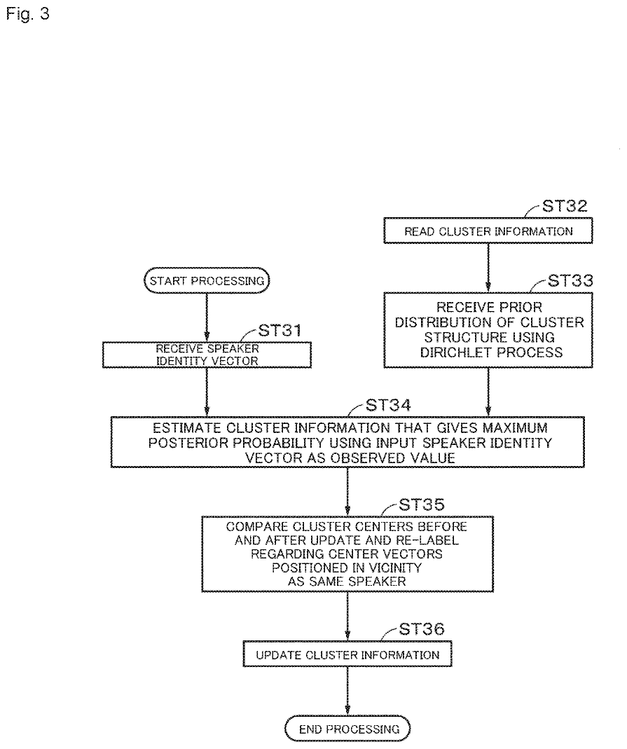

Next, an example of processing performed by the clustering unit 302 will be described with reference to the flowchart of FIG. 3. The processing shown in FIG. 3 is a method using nonparametric Bayesian. In step ST31, the speaker identity vector extracted from the speaker identity extraction unit is input to the clustering unit 302. The clustering unit 302 reads the cluster information stored in the database DB in step ST32, and inputs the prior distribution of the cluster structure using the Dirichlet process in step ST33. Then, the processing proceeds to step ST34.

In step ST34, clustering unit 302 estimates a cluster structure that gives the maximum posterior probability using the input speaker identity vector as an observed value. Then, the processing proceeds to step ST35.

In step ST35, the clustering unit 302 compares the cluster centers before and after the update, and performs re-labeling (grouping) regarding the center vectors positioned in the vicinity as the same speaker. Here, if the speaker is an existing speaker, the newly obtained speaker identity vector and the speaker identity vector of the existing speaker stored in the database DB are re-labeled as the same group, and the cluster information is calculated again using the speaker identity vectors belonging to the group. If the speaker is a new speaker, it is registered in the database as a cluster having the newly obtained speaker identity vector as the central vector. Then, the processing proceeds to step ST36.

In step ST36, the cluster information based on the speaker identity vector is updated. For example, statistics such as an average vector and a covariance matrix calculated from a plurality of speaker identity vectors re-labeled in step ST36 are written in the database DB as cluster information corresponding to a predetermined speaker.

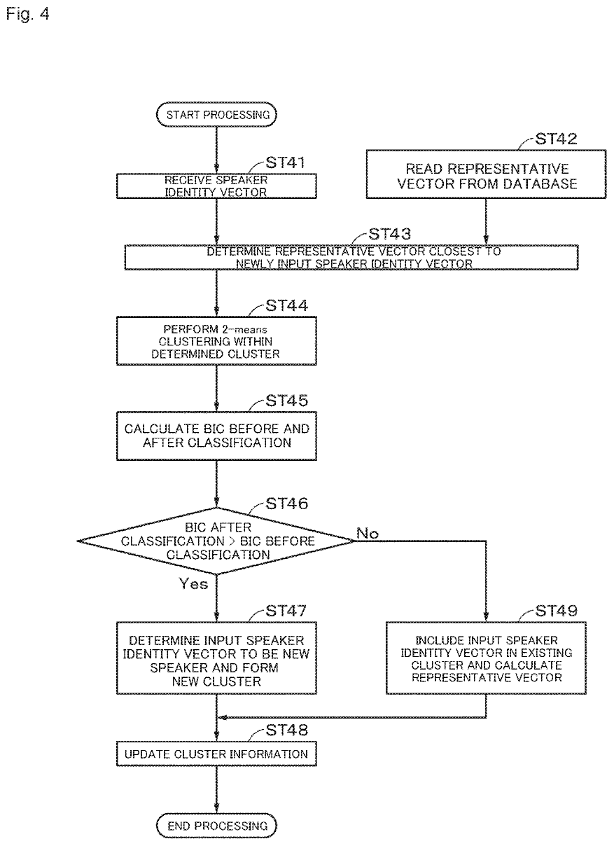

Another example of the processing performed by the clustering unit 302 will be described with reference to the flowchart of FIG. 4. The processing shown in FIG. 4 is a method using the Bayesian Information Criteria (hereinafter referred to as BIC as appropriate).

In step ST41, the speaker identity vector extracted by speaker identity extraction unit 301 is input to the clustering unit 302. Further, in step ST42, the clustering unit 302 reads statistics such as representative vectors and covariance matrices, which are cluster information of each speaker, from the database DB. Then, the processing proceeds to step ST43.

In step ST43, the newly input speaker identity vector and the closest representative vector are determined. Then, the processing proceeds to step ST44.

In step ST44, 2-means clustering is performed using the cluster to which the representative vector belongs and the speaker identity vector. Then, the processing proceeds to step ST45.

In step ST45, the BIC before classification and the BIC after classification by 2-means clustering are calculated. Then, the processing proceeds to step ST46.

In step ST46, the BIC before classification and the BIC after classification are compared. Then, it is determined whether the result of the comparison shows that BIC after classification is greater than BIC before classification. If BIC after classification is greater than BIC before classification, the processing proceeds to step ST47.

In step ST47, the speaker corresponding to the input speaker identity vector is determined to be a new speaker, and a new cluster of the new speaker is formed. Then, the processing proceeds to step ST48.

In step ST48, cluster information based on the speaker identity vector of the new speaker is generated, and the cluster information is stored in the database DB.

When the result of the determination process in step ST46 shows that BIC after classification is not greater than BIC before classification, the processing proceeds to step ST49. In step ST49, the speaker corresponding to the input speaker identity vector is determined to be an existing speaker. Then, after the input speaker identity vector is included in the cluster of the existing speaker, statistics such as representative vectors and covariance matrices are calculated. Then, the processing proceeds to step ST48.

In step ST48, statistics such as representative vectors and covariance matrices of existing speakers are updated as cluster information, and the cluster information is stored in the database DB.

### (Specific Example of Processing Performed by Target Speaker Voice Segment Detection Unit)

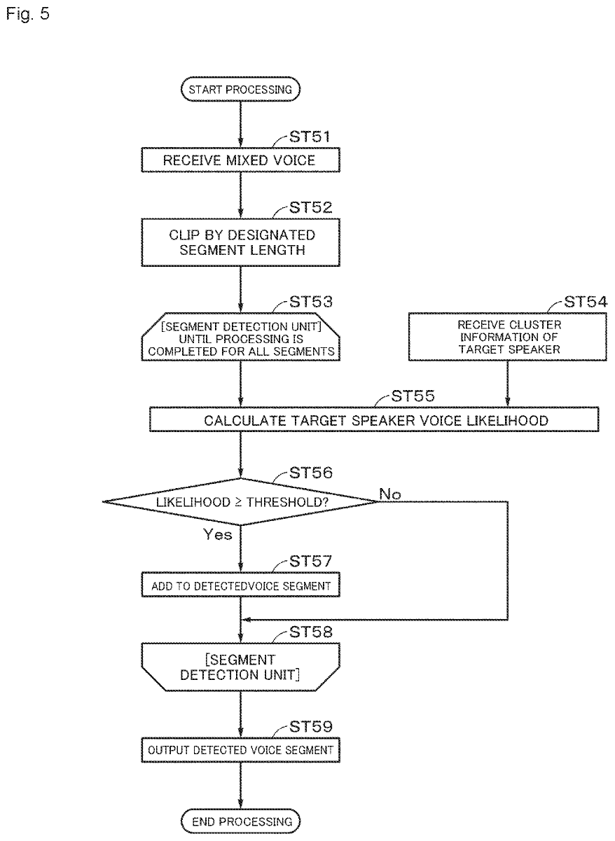

Next, a specific example of the processing performed by the target speaker voice segment detection unit 401 will be described with reference to the flowchart shown in FIG. 5. The processing shown in FIG. 5 is an example of detecting whether it is the target voice in units of segments.

In step ST51, the input voice signal S1, which is mixed voice, is input to the target speaker voice segment detection unit 401. Then, the processing proceeds to step ST52.

In step ST52, the target speaker voice segment detection unit 401 clips the input voice signal S1 by a designated segment length. Then, the processing proceeds to step ST53.

In steps ST53 to ST58, the processing of steps ST54 to ST57 described below is repeated until all segments are processed.

In step ST54, the representative vector, which is the cluster information of the target speaker, is input to the target speaker voice segment detection unit 401. Then, the processing proceeds to step ST55.

In step ST55, the target speaker voice segment detection unit 401 calculates a target speaker voice likelihood which indicates the possibility that the voice signal of a predetermined segment length contains the voice of the target speaker. For example, the target speaker voice segment detection unit 401 calculates the target speaker voice likelihood according to the similarity between the vector of the voice signal of a predetermined segment length and the representative vector. When the similarity is equal to or higher than a certain level, the possibility that the voice signal of the target speaker is included in the voice signal of the predetermined segment length increases, and the target speaker voice likelihood increases. Note that the target speaker voice likelihood may be calculated using a DNN (Deep Neural Network). Then, the processing proceeds to step ST56.

In step ST56, it is determined whether the target speaker voice likelihood is equal to or greater than a predetermined threshold. If the target speaker voice likelihood is less than the predetermined threshold, the processing proceeds to step ST58 to process the next segment. If the target speaker voice likelihood is greater than or equal to the predetermined threshold, the processing proceeds to step ST57.

In step ST57, since the target speaker voice likelihood is equal to or greater than the predetermined threshold, the voice signal of the segment is added to the detected voice segment indicating the segment of the voice of the target speaker. Then, the processing proceeds to step ST58 to process the next segment.

When the processing for all segments is completed, the processing proceeds to step ST59. In step ST59, the switch 402 is turned on, and the voice signal classified into the detected voice segment is supplied to the target speaker voice extraction unit 403.

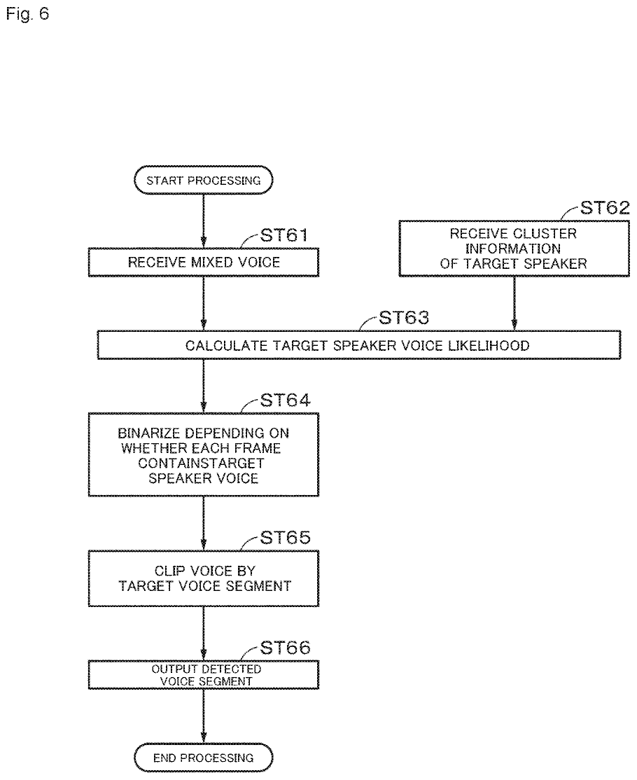

Next, another example of processing performed by the target speaker voice segment detection unit 401 will be described with reference to the flowchart shown in FIG. 6. The processing shown in FIG. 6 is an example of determining whether the voice signal contains the voice of the target speaker on a frame-by-frame basis.

In step ST61, the input voice signal S1, which is mixed voice, is input to the target speaker voice segment detection unit 401. In step ST62, the representative vector, which is the cluster information of the target speaker, is input to the target speaker voice segment detection unit 401. Then, the processing proceeds to step ST63.

In step ST63, the target speaker voice segment detection unit 401 calculates a target speaker voice likelihood which indicates the possibility that the voice signal of a predetermined frame contains the voice of the target speaker. Then, the processing proceeds to step ST64.

In step ST64, the voice signal of each frame is binarized depending on whether it contains the voice of the target speaker. For example, a flag (for example, “1” as a logical value) indicating the possibility that the voice signal of the target speaker is included is added to a voice signal whose target speaker voice likelihood is equal to or greater than a threshold is added with, and a flag (for example, “0” as a logical value) indicating that the voice signal of the target speaker is not included is added to a voice signal whose target speaker voice likelihood is less than the threshold. Then, the processing proceeds to step ST65.

In step ST65, a process of clipping the voice signal of the frame to which “1” is added as the flag is performed. Then, the processing proceeds to step ST66.

In step ST66, the clipped voice signal, that is, the voice signal of the target voice segment is output. Then, the processing ends.

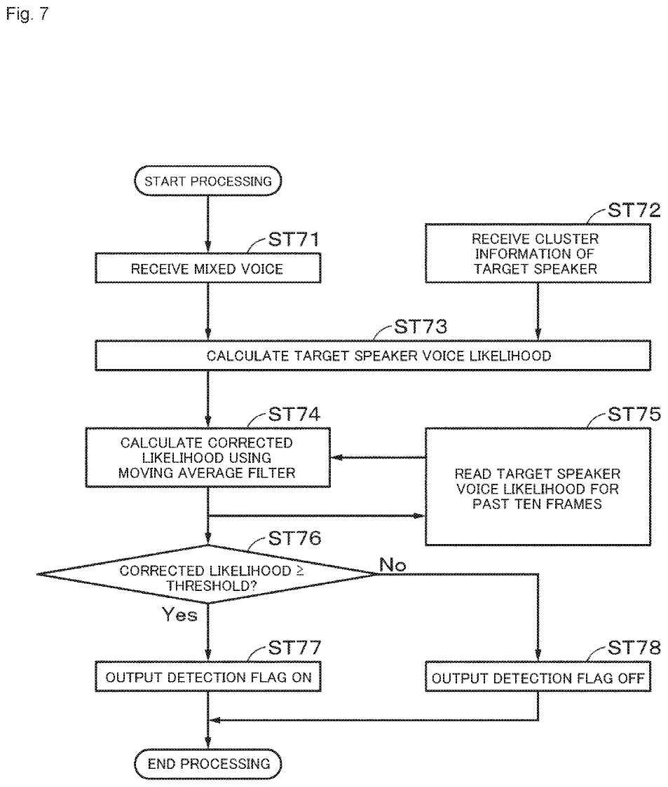

Next, another example of the processing performed by the target speaker voice segment detection unit 401 will be described with reference to the flowchart shown in FIG. 7.

The processing related to steps ST71 to ST73 is the same as the processing related to steps ST61 to ST63 described above. Then, the processing proceeds to step ST74.

In step ST74, a corrected likelihood is calculated by correcting the target speaker voice likelihood calculated in step ST73. Specifically, in step ST75, the target speaker voice likelihoods corresponding to the past 10 frames are read. The target speaker voice likelihoods of the past 10 frames are stored in an appropriate memory such as a buffer memory. Then, moving average filtering is performed using the target speaker voice likelihood calculated in step ST73 and the target speaker voice likelihoods corresponding to the past 10 frames, thereby calculating the corrected likelihood. As a result, it is possible to suppress unnatural fluctuations of the target speaker voice likelihood between frames.

After the corrected likelihood is calculated, the processing proceeds to step ST76. In step ST76, it is determined whether the corrected likelihood is greater than or equal to a predetermined threshold. If the corrected likelihood is greater than or equal to the predetermined threshold, the processing proceeds to step ST77.

In step ST77, a detection flag for turning on the switch 402 is output and the switch 402 is turned on. Then, the voice signal of the frame input in step ST71 is supplied to the target speaker voice extraction unit 403.

In step ST76, if the corrected likelihood is less than the predetermined threshold, the processing proceeds to step ST78. In step ST78, a detection flag for turning off the switch 402 is output and the switch 402 is turned off. The processing described above is performed for all frames.

### (Regarding Timings of Each Process)

Note that the updating of cluster information performed by the single speech detection system 20 and the speaker feature quantity extraction system 30 and the target speaker voice signal extraction process performed by the target speaker voice recognition system 40 may be performed in parallel (1 pass) or serially (two passes).

Here, parallel processing means processing in which the target speaker's voice signal is extracted while cluster information is being updated, and serial processing means processing in which the voice signal of the target speaker is extracted after the cluster information is obtained for all speakers (after the database is constructed).

The processing described above may be batch processing or real-time processing. Here, batch processing means that processing is performed after all voice signals are recorded by the microphone 10. Further, real-time processing means that other processing is simultaneously performed in predetermined units (for example, frame units) while recording is being performed.

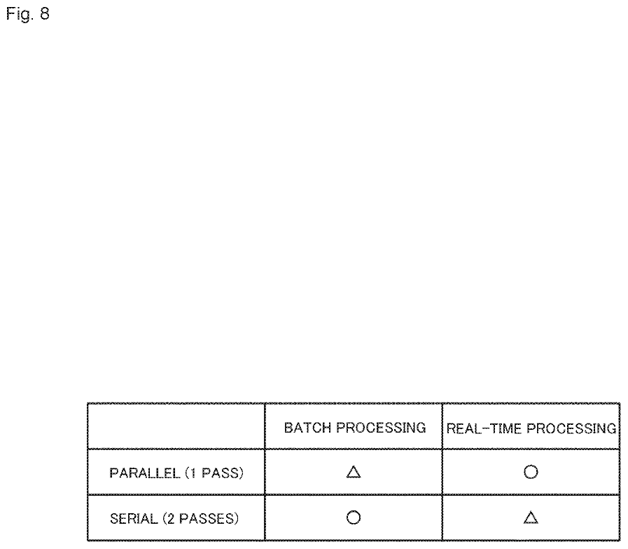

Four patterns shown in FIG. 8 are conceivable as combinations of parallel processing and serial processing, and batch processing and real-time processing. As shown in FIG. 8, a combination of parallel processing and real-time processing or a combination of serial processing and batch processing is preferable from the viewpoint of processing efficiency.

### [Example of how to Determine Target Speaker]

Next, an example of how to determine the target speaker will be described.

As an example, the target speaker is a speaker set (selected) in advance. In this case, if cluster information corresponding to the set speaker does not exist in the database DB, processing by the target speaker voice recognition system 40 may not be performed.

The target speakers may be all speakers whose cluster information exists in the database DB. In this case, the target speaker voice recognition system 40 may be provided in a number corresponding to all speakers, or all speakers may be sequentially processed by the target speaker voice recognition system 40.

The target speaker may be a plurality of speakers. The plurality of speakers may be preset speakers, or priorities may be given to the plurality of speakers, and only voices of several speakers with higher priority may be extracted.

### [Effect Obtained by Present Embodiment]

According to the present embodiment described above, for example, the following effects can be obtained.
For a new speaker whose speaker identity is not known, the speaker identity (cluster information in the present embodiment) can be obtained from the single speech of the speaker.
By detecting the presence segment of the target speaker's speech from the mixed voice input, the non-speech segment of the target voice can be rejected, and the case where the non-target voice in that segment is erroneously recognized as the target voice can be avoided.
By inputting only the voice clipped in the target speaker voice segment to the target speaker voice extraction unit 403, the calculation cost can be reduced compared to inputting all the voices.

### <Modification>

Although an embodiment of the present disclosure has been described above in detail, the content of the present disclosure is not limited to the above-described embodiment and various modifications based on the technical spirit of the present disclosure can be made.

### [Modification 1]

A speaker identity vector, which is one of the feature quantities used in one embodiment, is a vector that aggregates phoneme information and pitches of a certain speech. If the speaker identity vector is averaged in the time direction, there is a possibility that changes over time during speech cannot be considered so much. If a vector obtained by further averaging a plurality of speaker identity vectors is used for processing, there is a possibility that the amount of information possessed by the speaker identity vector will be lost.

In addition, when the number of pre-registered speeches registered in the database DB and the like, specifically, the number of speaker identity vectors of a certain target speaker is extremely small, or when it is 0, it becomes difficult to detect a single speech and a voice segment and extract a voice, and there is a possibility that the processing accuracy may be lowered. In addition, when the quality of the speaker identity vector to be referred to cannot be guaranteed due to factors such as the presence of a large amount of non-voice noise, it is desirable to be able to expand the speaker identity vector that can be referred to. This modification is an example corresponding to such a viewpoint.

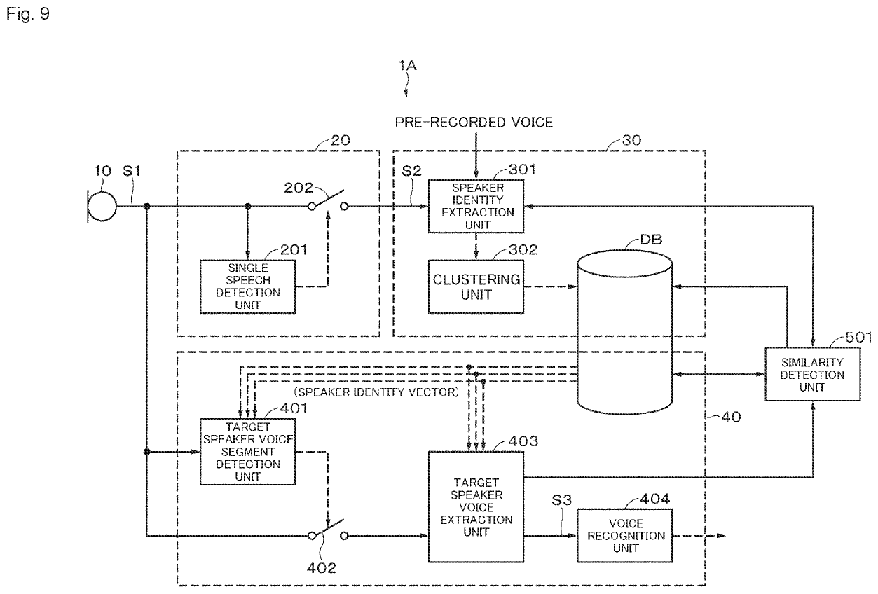

FIG. 9 is a block diagram showing a configuration example of a signal processing device (signal processing device 1A) according to Modification 1. Differences of the signal processing device 1A from the signal processing device 1 according to one embodiment will be schematically described. The signal processing device 1A further has a similarity determination unit 501. The similarity determination unit 501 is connected to each of the speaker identity extraction unit 301, the target speaker voice extraction unit 403, and the database DB. Further, in this modification, the details of the processing performed by the target speaker voice segment detection unit 401 and the target speaker voice extraction unit 403 are different from those of the embodiment.

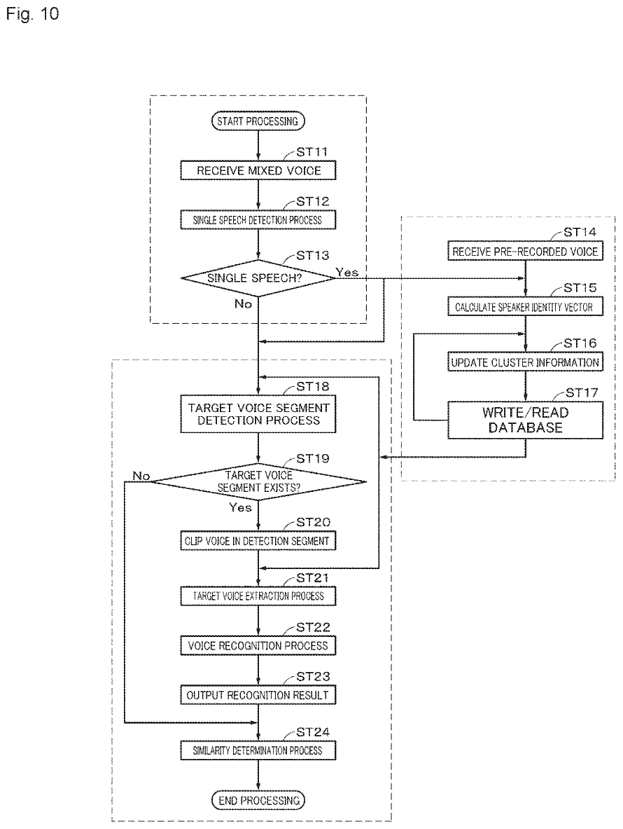

FIG. 10 is a flowchart showing the flow of processing performed by the signal processing device 1A. In this modification, the contents of the target voice segment detection process performed in step ST18 and the target voice extraction process performed in step ST21 are different from those of the embodiment. In step ST24 following step ST23, the similarity determination unit 501 performs a similarity determination process.

The target speaker voice segment detection unit 401 uses a learning model obtained by pre-learning to detects whether the mixed voice signal input via the microphone 10 contains the voice signal of the target speaker. If the voice signal of the target speaker is included, the segment is set as the speech segment, and the switch 402 is turned on. The target speaker voice segment detection unit 401 uses a two-input, one-output learning model. The two inputs are a mixed voice signal and a plurality of pieces of cluster information (cluster information based on voice feature quantities). One output is the presence or absence of the voice signal of the target speaker. Note that, in this example, as the cluster information, a voice feature quantity, more specifically, a speaker identity vector will be described as an example. That is, the target speaker voice segment detection unit 401 uses a plurality of speaker identity vectors supplied from the database DB to detect the presence or absence of the target speaker's voice signal.

The target speaker voice extraction unit 403 operates in the same manner as the target speaker voice segment detection unit 401 except that it extracts the target speaker's voice signal instead of the presence or absence of the target speaker's voice signal. The target speaker voice extraction unit 403 extracts the target speaker's voice signal from the mixed voice signal input via the microphone 10 using a learning model obtained by pre-learning. The target speaker voice extraction unit 403 uses a two-input, one-output learning model. The two inputs are a mixed voice signal and a plurality of pieces of cluster information (cluster information based on voice feature quantities). One output is the voice signal of the target speaker. That is, the target speaker voice extraction unit 403 extracts the target speaker's voice signal using a plurality of speaker identity vectors supplied from the database DB. The target speaker may be set by users, or may be automatically set according to a predetermined rule.

A specific example of learning performed by the target speaker voice extraction unit 403 and inference using a learning model obtained by the learning will be described. Learning is performed to extract the voice signal of the target speaker from the mixed voice signal and a plurality of speaker identity vectors. As a learning model, any model that satisfies the two-input, one-output configuration can generally be used, but from the viewpoint of online processing, it is desirable to use a convolutional neural network. This is because a recurrent neural network is effective for processing in block units, but it is not expected to be very effective when used with short sequence lengths. As learning, supervised learning is assumed. The learning data uses a corpus used for learning sound source separation models such as WSJO-2mix and Libri2Mix. Paired data for the target speaker voice extraction model is generated by appropriately selecting a plurality of mixed speeches containing the voice signal of the target speaker and other speeches as the reference speeches. During inference, just like during learning, only the voice signal of the target speaker is extracted by inputting mixed speeches and (multiple) reference speeches into the model. In general, since the closer the data domain is to the time of learning, the more the model's inherent performance can be extracted, it is desirable to prepare learning data according to the use case in the learning stage in advance. The data domain in this example means features such as language, amount of noise, and amount of echo.

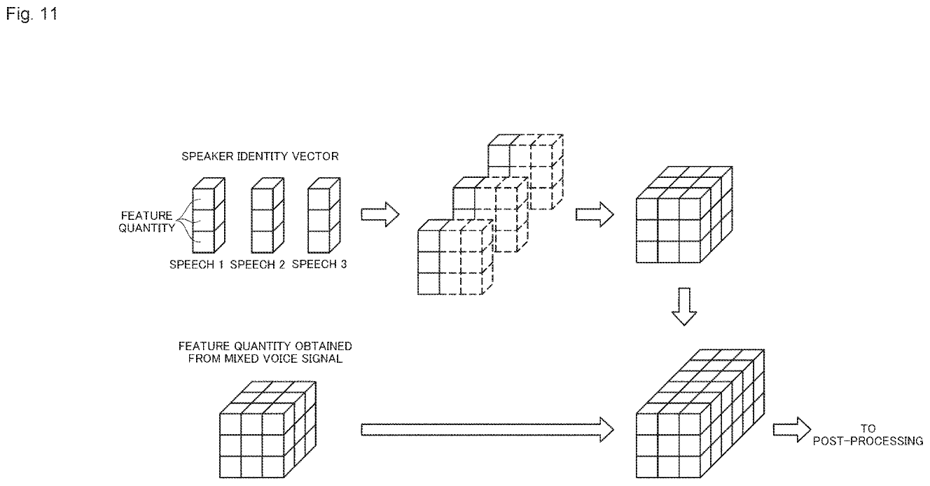

The voice extraction process performed by the target speaker voice extraction unit 403 will be described more specifically with reference to FIG. 11. The three speaker identity vectors (speaker identity vectors corresponding to speeches 1, 2, and 3, respectively) shown in FIG. 11 have dimensions of features (three features). Features include pitch, volume, and the like. Since each speaker identity vector itself does not have time information, features of the speaker identity vector are copied in the time direction (horizontal direction in FIG. 11), and these are combined in the depth direction. A feature quantity can also be obtained from a mixed voice signal. The speaker identity vector expanded and combined in the time direction and the feature quantity obtained from the mixed voice signal are connected and sent to post-processing. That is, the voice signal of the target speaker is extracted by inputting the 3×3×6 rectangular cells (schematic representation of the matrix) shown in FIG. 11 into the neural network of a learned model.

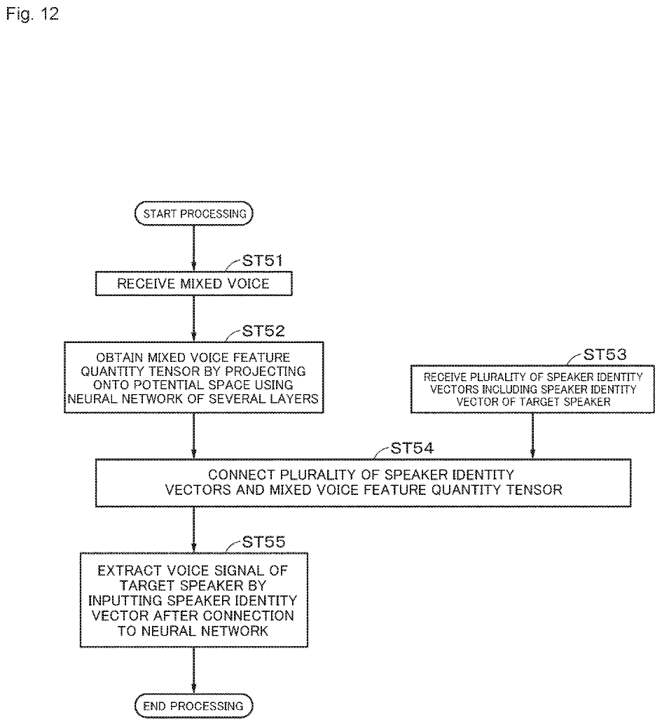

FIG. 12 is a flowchart showing the flow of processing shown in FIG. 11. In step ST51, a mixed voice signal is input to the target speaker voice extraction unit 403. Then, the processing proceeds to step ST52. In step ST52, the target speaker voice extraction unit 403 obtains a mixed voice feature quantity tensor, which is the feature quantity of the mixed voice signal, by projecting the mixed voice signal onto the potential space using a neural network of several layers. Then, the processing proceeds to step ST54.

In parallel with the processing of steps ST51 and ST52, a plurality of speaker identity vectors including the speaker identity vector of the target speaker are input to target speaker voice extraction unit 403 from database DB.

In step ST54, the target speaker voice extraction unit 403 connects a plurality of speaker identity vectors and the mixed voice feature quantity tensor. Then, the processing proceeds to step ST55.

In step ST55, the voice signal of the target speaker is extracted by inputting the speaker identity vector after connection to the learned neural network.

In this way, by using a learning model that has learned in advance how to weight a plurality of speaker identity vectors and how to extract the speech segment and voice signal of the target speaker, it is possible to detect and extract the speech segment and voice signal of the target speaker with high accuracy.

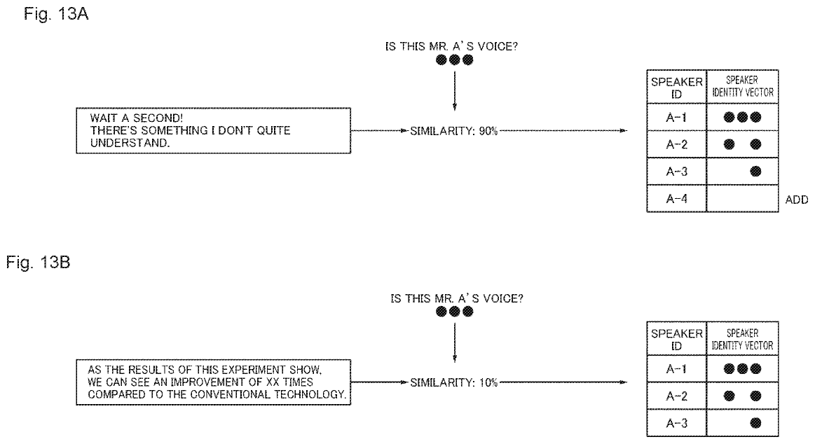

Next, an example of a similarity determination process according to Modification 1 will be described. FIG. 13 is a diagram for explaining an outline of a similarity determination process. The voice signal of the target speaker is extracted by the target speaker voice extraction unit 403 described above. The similarity determination unit 501 calculates the similarity between the target speaker's voice signal extracted by the target speaker voice extraction unit 403 and the target speaker's voice signal registered in the database DB. Then, as shown in FIG. 13A, if the calculated similarity is greater than a threshold (for example, 70%), the similarity determination unit 501 adds the feature quantities (for example, the speaker identity vectors) of the voice signal of the target speaker extracted by the target speaker voice extraction unit 403 to the database DB. On the other hand, since the learning model used in the target speaker voice extraction unit 403 is not versatile, there are cases where the similarity is below the threshold (for example, similarity 10%), as shown in FIG. 13B. In this case, the similarity determination unit 501 does not add the feature quantity of the voice signal of the target speaker extracted by the target speaker voice extraction unit 403 to the database DB. Note that the voice recognition process by the voice recognition unit 404 may not be performed when the similarity is below the threshold.

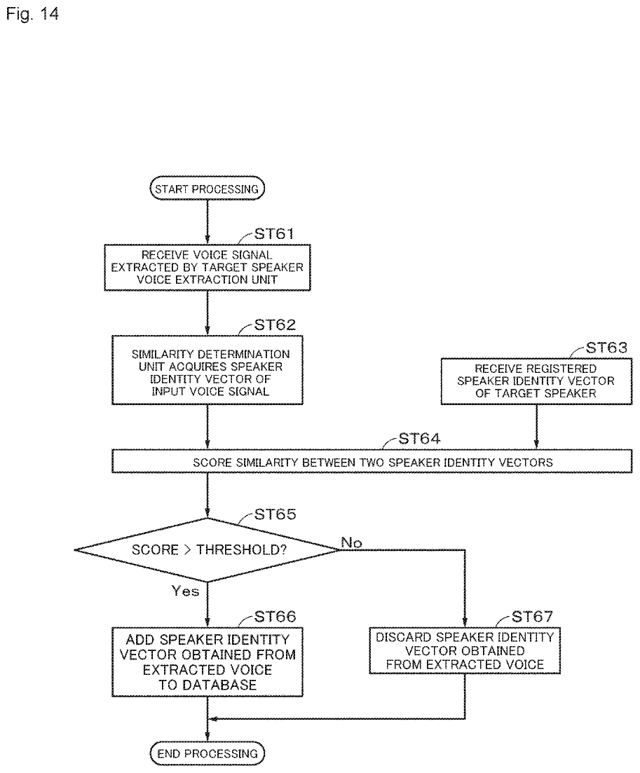

An example of the similarity determination process will be described in detail with reference to the block diagram of FIG. 9 and the flowchart of FIG. 14. In step ST 61 in the flowchart of FIG. 14, the target speaker's voice signal extracted by the target speaker voice extraction unit 403 is input to the similarity determination unit 501. Then, the processing proceeds to step ST62.

In step ST62, the similarity determination unit 501 supplies the input voice signal of the target speaker to the speaker identity extraction unit 301. The speaker identity extraction unit 301 extracts a speaker identity vector by performing a speaker identity extraction process on the voice signal supplied from the similarity determination unit 501, and supplies the extracted speaker identity vector (hereinafter referred to as the extracted speaker identity vector as appropriate) to the similarity determination unit 501. As a result, the similarity determination unit 501 acquires the speaker identity vector (that is, the extracted speaker identity vector) corresponding to the voice signal of the target speaker extracted by the target speaker voice extraction unit 403.

In parallel with the processing of steps ST61 and ST62, the processing of step ST63 is performed. In step ST63, the similarity determination unit 501 reads out the speaker identity vector (hereinafter referred to as a registered speaker identity vector as appropriate) of the target speaker registered in the database DB from the database DB. Then, the processing proceeds to step ST64.

In step ST64, the similarity determination unit 501 calculates the similarity between two speaker identity vectors, that is, between the extracted speaker identity vector and the registered speaker identity vector. Similarity is calculated by applying a known method. Then, the similarity determination unit 501 quantifies (scores) the calculated similarity. Then, the processing proceeds to step ST65.

In step ST65, the similarity determination unit 501 compares the score corresponding to the similarity with a threshold. If the score corresponding to the similarity is greater than the threshold, the processing proceeds to step ST66.

In step ST66, the similarity determination unit 501 determines that the voice signal extracted by the target speaker voice extraction unit 403 is a voice signal corresponding to the target speaker. Then, the similarity determination unit 501 stores the speaker identity vector of the voice signal, that is, the extracted speaker identity vector extracted by the speaker identity extraction unit 301 in the database DB as a new feature quantity corresponding to the speech serving as the target speaker. Then, the processing ends.

On the other hand, when it is determined that the score corresponding to the similarity is equal to or less than the threshold in the determination process of step ST65, the processing proceeds to step ST67. In step ST67, the similarity determination unit 501 determines that the voice signal extracted by the target speaker voice extraction unit 403 is not a voice signal corresponding to the target speaker. In this case, the similarity determination unit 501 discards the extracted speaker identity vector without registering it in database DB.

According to this modification, it is possible to increase the number of speaker identity vectors registered in the database DB. Further, by registering only the speaker identity vectors determined to have a certain similarity or more, it is possible to prevent decrease in the accuracy of the voice segment detection process and the voice extraction process using speaker identity vectors.

### [Modification 2]

There are cases where the number of registered speaker identity vectors corresponding to the speaker set as the target speaker is 0, or the number is less than the number required to obtain sufficient accuracy in performing the voice extraction process. In this case, the voice signal of the target speaker may be extracted by extracting the voice signal of a speaker other than the target speaker (hereinafter also referred to as an interfering speaker) from the mixed voice signal and subtracting the extracted voice signal of the interfering speaker from the mixed voice signal.

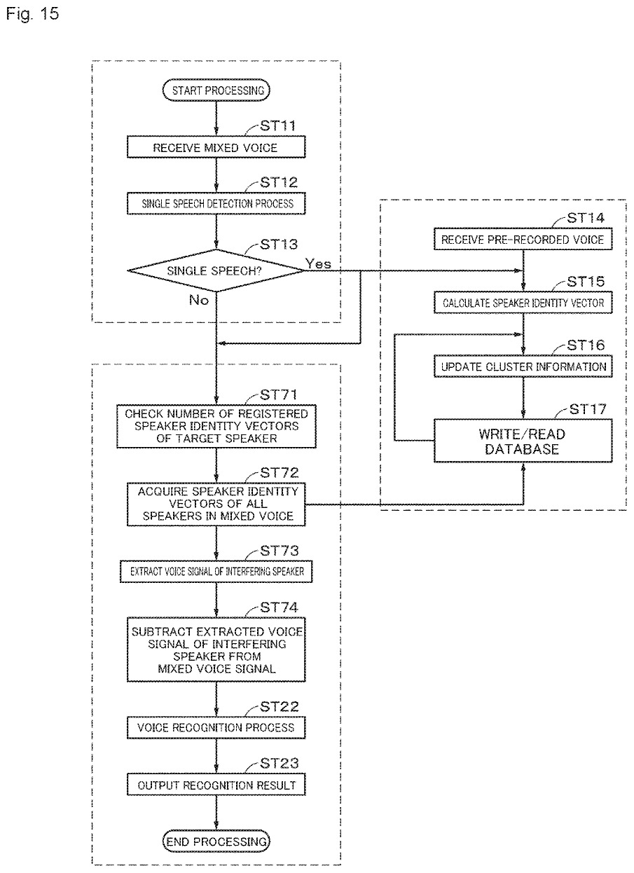

FIG. 15 is a flow chart showing the flow of processing performed by a signal processing device according to Modification 2. Differences from the embodiment or Modification 1 described above will be described.

When the determination result in step ST13 is No, the processing proceeds to step ST71. In step ST71, the target speaker voice extraction unit 403 accesses the database DB and checks the number of registered speaker identity vectors of the speaker set as the target speaker. Here, if the number of registered speaker identity vectors is equal to or less than the threshold, the processing proceeds to step ST72. Note that when the number of registered speaker identity vectors is sufficiently greater than the threshold, the voice signal of the target speaker is extracted by performing the same processing as in the embodiment and Modification 1.

In step ST72, the target speaker voice extraction unit 403 reads the speaker identity vectors of all the speakers (excluding the target speaker) included in the mixed voice signal from the database DB. For example, the target speaker voice extraction unit 403 reads the speaker identity vectors of all interfering speakers other than the target speaker from the database DB. Then, the processing proceeds to step ST73.

In step ST73, the target speaker voice extraction unit 403 extracts the voice signal of each interfering speaker. That is, the target speaker voice extraction unit 403 extracts a voice signal of a certain interfering speaker using the plurality of speaker identity vectors read in step ST72. Next, similar processing is performed to extract the voice signal of another interfering speaker. By repeating this, the target speaker voice extraction unit 403 extracts the voice signals of all interfering speakers included in the mixed voice signal. Then, the processing proceeds to step ST74.

In step ST74, the target speaker voice extraction unit 403 subtracts the voice signal of the interfering speaker extracted in step ST73 from the mixed voice signal. As a result, the target speaker's voice signal is obtained by the target speaker voice extraction unit 403. The voice recognition process and the like are subsequently performed on the acquired voice signal of the target speaker.

### [Modification 3]

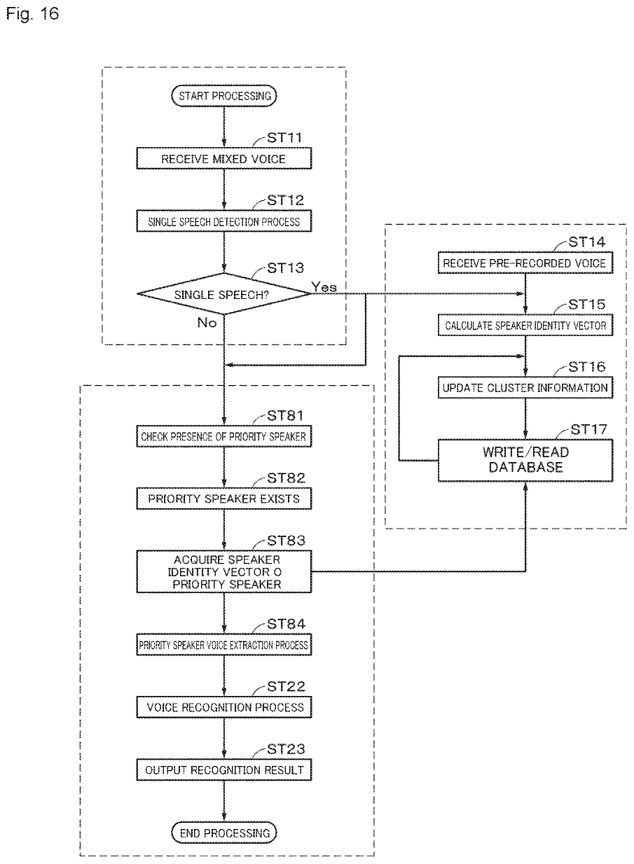

Even when the target speaker is set, if a priority speaker that has priority over the target speaker is set, the voice signal of the priority speaker instead of the target speaker may be extracted. FIG. 16 is a flowchart showing the flow of processing when performing such processing.

When the determination result in step ST13 is No, the processing proceeds to step ST81. In step ST81, the target speaker voice extraction unit 403 checks the setting of the signal processing device to check whether the priority speaker has been set. Next, the processing proceeds to step ST82. In step ST82, the target speaker voice extraction unit 403 confirms that a priority speaker is set. Note that when the priority speaker is not set, the voice signal of the target speaker is extracted by performing the same processing as in the embodiment and Modifications 1 and 2. Then, the processing proceeds to step ST83.

In step ST83, the target speaker voice extraction unit 403 reads the speaker identity vector of the priority speaker from the database DB. Then, the processing proceeds to step ST84.

In step ST84, the target speaker voice extraction unit 403 performs a priority speaker voice extraction process of extracting the voice signal of the priority speaker from the mixed voice signal using the speaker identity vector of the priority speaker. In this way, the voice signal of the priority speaker is acquired. The voice recognition process and the like are subsequently performed on the extracted voice signal of the priority speaker. In the priority speaker voice extraction process, the voice signal of the priority speaker is extracted by the method described in the embodiment and the modification. As described above, in this modification, when the priority speaker is set, the target speaker voice extraction unit functions as a priority speaker voice extraction unit.

### [Modification 4]

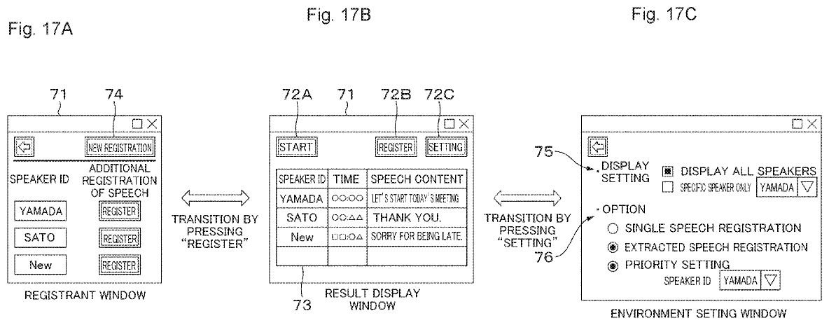

FIG. 17 shows an example of a GUI applicable to the present disclosure. The GUI is displayed on a display unit 71, for example. The display unit 71 may be included in the signal processing device according to the embodiment or modification, or may be included in another device different from the signal processing device. In this example, it is assumed that the signal processing device according to the present disclosure has the display unit 71.

The GUI shown in the center (FIG. 17B) is an example of a screen displayed when the processing of the signal processing device ends. The display unit 71 displays a start button 72A, a registration button 72B, and a setting button 72C. Further, in the vicinity of the center of the display unit 71, for example, the result of performing the voice extraction process or the like on the voice signal of a predetermined minutes is displayed. The example shown in FIG. 17B shows an example in which speeches of “Yamada”, “Sato”, and a new speaker (a speaker whose speaker identity vector is not found in the database DB) are detected. For example, when the registration button 72B is operated, the GUI transitions from FIG. 17B to FIG. 17A.

In FIG. 17A, a registration button is displayed next to the speaker name. When the registration button is operated, the speaker identity vector of the speaker corresponding to the button is registered in the database DB. Further, as shown in FIG. 17A, the display unit 71 displays a button 74 of “new registration”. By operating the button 74, the voice of any new speaker and the feature quantity of the voice can be registered.

When the setting button 72C shown in FIG. 17B is operated, the GUI transitions from FIG. 17B to FIG. 17C. FIG. 17C shows an example of the setting screen. For example, an item 75 of “display settings” is displayed on the display unit 71. By checking the item or selecting a speaker from a pull-down menu, it is possible to set whose voice extraction result is to be displayed. Further, an item 76 of “options” is displayed. Here, whether to register the speaker identity vector corresponding to the speech detected as a single speech, to register the speaker identity vector corresponding to the extracted voice of the target speaker, or to register the speaker identity vector corresponding to the extracted voice of the priority speaker can be set. Further, it is possible to set who is the priority speaker.

### [Modification 5]

The present disclosure can be applied not only to voice recognition, but also to automatic transcription of meeting minutes and discussions. In addition, the present disclosure can also be applied to record conversations of surgeons during surgery when handwriting is not possible at medical sites. In addition, the present disclosure can also be applied to automatically recognize the speeches of announcers and performers in video content, and automatically generate and display subtitles based on the recognition results.

### [Modification 6]

The signal processing device 1 according to the above-described embodiment (or the signal processing device according to the modification) may have a noise suppression unit that removes noise. The noise suppression unit is provided, for example, before or after the single speech detection unit 201. When the noise suppression unit is placed in the preceding stage, by suppressing non-voice noise other than voice, single speech detection is not disturbed by non-voice noise, and the accuracy of single speech detection can be improved. In addition, when the noise suppression unit is placed in the latter stage, there is no distortion due to artificial voice processing. Therefore, if single speech detection is sufficiently robust against non-voice noise, unnatural behavior due to distortion can be suppressed.

The signal processing device 1 according to the above-described embodiment (or the signal processing device according to the modification) may have the configuration related to the single speech detection system 20 and the speaker feature quantity extraction system 30 (the configuration without the target speaker voice recognition system 40), or may have only the configuration related to the target speaker voice recognition system 40. Further, part of the processing performed by the signal processing device 1 described above may be performed by a server device or the like on the cloud. The database may be located not in the signal processing device 1 but in a cloud server device or the like. The input voice signal may be a multi-channel signal. In this case, the single speech detection unit detects whether any of the input voice signals of the plurality of channels contains the speech of the single speaker. The cluster information updating unit updates the cluster information based on the voice feature quantity when any one of the input voice signals of the plurality of channels is the speech of a single speaker. The voice extraction unit extracts only the voice signal of the target speaker from the multi-channel mixed voice signal containing the voice of the target speaker.

The configurations, methods, steps, shapes, materials, numerical values, and others mentioned in the above-described embodiment and modifications are merely examples. Instead, different configurations, methods, steps, shapes, materials, numerical values, and others may be used as necessary, and they may also be replaced with known ones. Further, the configurations, methods, steps, shapes, materials, numerical values, and others in the embodiment and modifications can be combined with each other as long as no technical contradiction occurs.

The content of the present specification is not construed to be limitative by the advantageous effects exemplified in the present disclosure.

The present disclosure can also employ the following configurations.

(1)

A signal processing device comprising: a single speech detection unit that detects whether one channel of an input voice signal is a speech of a single speaker;

a cluster information updating unit that updates cluster information based on a voice feature quantity when the input voice signal is a speech of a single speaker;
a voice segment detection unit that detects a speech segment of a target speaker based on the cluster information; and
a voice extraction unit that extracts only the voice signal of the target speaker from a mixed voice signal containing the voice of the target speaker.
(2)

The signal processing device according to (1), further comprising: a speaker identity extraction unit that extracts the voice feature quantity from a single voice signal corresponding to the speech of the single speaker detected by the single speech detection unit.

(3)

The signal processing device according to (1) or (2), wherein the speaker identity extraction unit extracts the voice feature quantity using a neural network.

(4)

The signal processing device according to (2) or (3), wherein the speaker identity extraction unit further extracts a voice feature quantity of an input voice signal input in advance.

(5)

The signal processing device according to any one of (1) to (4), wherein when the single speaker is a new speaker, the cluster information updating unit adds cluster information based on a voice feature quantity of the new speaker extracted by the speaker identity extraction unit, and when the single speaker is an existing speaker, updates cluster information based on a voice feature quantity of the existing speaker extracted by the speaker identity extraction unit.

(6)

The signal processing device according to any one of (1) to (5), wherein the voice signal of the target speaker is extracted while the cluster information is being updated.

(7)

The signal processing device according to any one of (1) to (5), wherein after obtaining the cluster information corresponding to all speakers, extraction of the voice signal of the target speaker is performed.

(8)

The signal processing device according to any one of (1) to (7), further comprising: a noise suppression unit provided in a preceding stage of the single speech detection unit.

(9)

The signal processing device according to any one of (1) to (7), further comprising: a noise suppression unit provided in a latter stage of the single speech detection unit.

(10)

The signal processing device according to any one of (1) to (9), wherein the target speaker is a set speaker.

(11)

The signal processing device according to any one of (1) to (9), wherein the target speaker is a plurality of speakers for which the cluster information corresponding thereto is obtained.

(12)

The signal processing device according to (11), wherein the target speaker is a part of speakers with higher priorities among the plurality of speakers.

(13)

The signal processing device according to any one of (1) to (12), further comprising: a database in which the cluster information is stored.

(14)

The signal processing device according to any one of (1) to (13), wherein the voice segment detection unit detects whether there is a speech segment of the target speaker based on a plurality of pieces of cluster information.

(15)

The signal processing device according to any one of (1) to (14), wherein the voice extraction unit extracts only the voice signal of the target speaker based on a plurality of pieces of the cluster information.

(16)

The signal processing device according to any one of (1) to (15), further comprising: a similarity determination unit that determines a similarity between the cluster information of the voice signal of the target speaker extracted by the voice extraction unit and the cluster information of the voice signal of the target speaker obtained in advance.

(17)

The signal processing device according to (16), wherein cluster information of the voice signal of the target speaker extracted by the voice extraction unit, the cluster information being determined to have the similarity equal to or higher than a predetermined threshold is stored.

(18)

A signal processing device comprising: a single speech detection unit that detects whether a speech of a single speaker is included in any of a plurality of channels of input voice signals;

a cluster information updating unit that updates cluster information based on a voice feature quantity when any of the plurality of channels of the input voice signals is a speech of a single speaker;
a voice segment detection unit that detects a speech segment of a target speaker based on the cluster information; and
a voice extraction unit that extracts only the voice signal of the target speaker from a plurality of channels of mixed voice signals containing the voice of the target speaker.
(19)

A signal processing method comprising: allowing a single speech detection unit to detect whether one channel of an input voice signal is a speech of a single speaker;

allowing a cluster information updating unit to update cluster information based on a voice feature quantity when the input voice signal is a speech of a single speaker;
allowing a voice segment detection unit to detect a speech segment of a target speaker based on the cluster information; and
allowing a voice extraction unit to extract only the voice signal of the target speaker from a mixed voice signal containing the voice of the target speaker.
(20)

A program for causing a computer to execute a signal processing method comprising: allowing a single speech detection unit to detect whether one channel of an input voice signal is a speech of a single speaker;

allowing a cluster information updating unit to update cluster information based on a voice feature quantity when the input voice signal is a speech of a single speaker;
allowing a voice segment detection unit to detect a speech segment of a target speaker based on the cluster information; and
allowing a voice extraction unit to extract only the voice signal of the target speaker from a mixed voice signal containing the voice of the target speaker.

### REFERENCE SIGNS LIST

1 Signal processing device
10 Microphone
201 Single speech detection unit
301 Speaker identity extraction unit
302 Clustering unit
401 Target speaker voice segment detection unit
403 Target speaker voice extraction unit
404 Speech recognition unit
501 Similarity determination unit
DB Database

1. A signal processing device comprising:
a single speech detection unit that detects whether one channel of an input voice signal is a speech of a single speaker;
a cluster information updating unit that updates cluster information based on a voice feature quantity when the input voice signal is a speech of a single speaker;
a voice segment detection unit that detects a speech segment of a target speaker based on the cluster information; and
a voice extraction unit that extracts only the voice signal of the target speaker from a mixed voice signal containing the voice of the target speaker.

2. The signal processing device according to claim 1, further comprising:
a speaker identity extraction unit that extracts the voice feature quantity from a single voice signal corresponding to the speech of the single speaker detected by the single speech detection unit.

3. The signal processing device according to claim 2, wherein
the speaker identity extraction unit extracts the voice feature quantity using a neural network.

4. The signal processing device according to claim 2, wherein
the speaker identity extraction unit further extracts a voice feature quantity of an input voice signal input in advance.

5. The signal processing device according to claim 1, wherein
when the single speaker is a new speaker, the cluster information updating unit adds cluster information based on a voice feature quantity of the new speaker extracted by the speaker identity extraction unit, and when the single speaker is an existing speaker, updates cluster information based on a voice feature quantity of the existing speaker extracted by the speaker identity extraction unit.

6. The signal processing device according to claim 1, wherein
the voice signal of the target speaker is extracted while the cluster information is being updated.

7. The signal processing device according to claim 1, wherein
after obtaining the cluster information corresponding to all speakers, extraction of the voice signal of the target speaker is performed.

8. The signal processing device according to claim 1, further comprising:
a noise suppression unit provided in a preceding stage of the single speech detection unit.

9. The signal processing device according to claim 1, further comprising:
a noise suppression unit provided in a latter stage of the single speech detection unit.

10. The signal processing device according to claim 1, wherein
the target speaker is a set speaker.

11. The signal processing device according to claim 1, wherein
the target speaker is a plurality of speakers for which the cluster information corresponding thereto is obtained.

12. The signal processing device according to claim 11, wherein
the target speaker is a part of speakers with higher priorities among the plurality of speakers.

13. The signal processing device according to claim 1, further comprising:
a database in which the cluster information is stored.

14. The signal processing device according to claim 1, wherein
the voice segment detection unit detects whether there is a speech segment of the target speaker based on a plurality of pieces of cluster information.

15. The signal processing device according to claim 1, wherein
the voice extraction unit extracts only the voice signal of the target speaker based on a plurality of pieces of the cluster information.

16. The signal processing device according to claim 1, further comprising:
a similarity determination unit that determines a similarity between the cluster information of the voice signal of the target speaker extracted by the voice extraction unit and the cluster information of the voice signal of the target speaker obtained in advance.

17. The signal processing device according to claim 16, wherein
cluster information of the voice signal of the target speaker extracted by the voice extraction unit, the cluster information being determined to have the similarity equal to or higher than a predetermined threshold is stored.

18. A signal processing device comprising:
a single speech detection unit that detects whether a speech of a single speaker is included in any of a plurality of channels of input voice signals;
a cluster information updating unit that updates cluster information based on a voice feature quantity when any of the plurality of channels of the input voice signals is a speech of a single speaker;
a voice segment detection unit that detects a speech segment of a target speaker based on the cluster information; and
a voice extraction unit that extracts only the voice signal of the target speaker from a plurality of channels of mixed voice signals containing the voice of the target speaker.

19. A signal processing method comprising:
allowing a single speech detection unit to detect whether one channel of an input voice signal is a speech of a single speaker;
allowing a cluster information updating unit to update cluster information based on a voice feature quantity when the input voice signal is a speech of a single speaker;
allowing a voice segment detection unit to detect a speech segment of a target speaker based on the cluster information; and
allowing a voice extraction unit to extract only the voice signal of the target speaker from a mixed voice signal containing the voice of the target speaker.

20. A program for causing a computer to execute a signal processing method comprising:
allowing a single speech detection unit to detect whether one channel of an input voice signal is a speech of a single speaker;
allowing a cluster information updating unit to update cluster information based on a voice feature quantity when the input voice signal is a speech of a single speaker;
allowing a voice segment detection unit to detect a speech segment of a target speaker based on the cluster information; and
allowing a voice extraction unit to extract only the voice signal of the target speaker from a mixed voice signal containing the voice of the target speaker.
